(19) United States
(12) Patent Application Publication
(10) Pub. No.: US 2002/0009207 A1
(43) Pub. Date: Jan. 24, 2002

(54) Connection method for microphone of mobile radio communication unit and connection structure thereof

(76) Inventor: Jong-Dal Kim, Kyungki-do (KR)

Correspondence Address: Alan H. MacPherson, SKJERVEN, MORRILL, MacPHERSON,, FRANKLIN & FRIEL, LLP, 25 Metro Drive, Suite 700, San Jose, CA, 95110-1349, US

(21) Appl. No.: 09/896,336

(22) Filed: Jun. 28, 2001

(30) Foreign Application Priority Data
Jun. 30, 2000 (KR) 2000-37256

(51) Int. Cl. H04R 9/08; H04R 11/04

(52) U.S. Cl. 381/361; 381/365

(57) ABSTRACT

Disclosed are a connection method for a microphone mounted in a mobile radio communication unit and a connection structure thereof, in which the connection of the microphone to a printed circuit board is made using circular conductive contacts formed at a holder made of a rubber material to protect the microphone, thereby being capable of conveniently achieving the connection between the microphone and the printed circuit board without using wires involving a welding process, as in conventional cases, while reducing the assembling time of the product, achieving an improvement in workability, and preventing an interference with peripheral components and a degradation in the connection resulting in a degradation in the reliability of the product. Alternatively, the connection of the microphone to a printed circuit board is made using a connector coated with a conductive adhesive (or a nonconductive adhesive) at both surfaces thereof. In this case, a movement preventing rim is protruded from the periphery of the microphone at the upper end of the microphone. In this case, it is also possible to minimize an increase in thickness resulting from the connection between the microphone and the printed circuit board, thereby achieving a miniature and lightness of a housing of the mobile radio communication unit.

### BACKGROUND OF THE INVENTION

1. Field of the Invention

The present invention relates to a connection for a microphone mounted in a mobile radio communication unit such as a handphone or a radio transceiver, and more particularly to a connection method for a microphone mounted in a mobile radio communication unit and a connection structure thereof which are capable of conveniently achieving a circuit connection of the microphone with a printed circuit board without any interference while achieving an easy mounting of the microphone.

2. Description of the Related Art

As well known, a microphone is mounted in a mobile radio communication unit such as a handphone or a radio transceiver. Such a microphone is electrically connected to a printed circuit board mounted in a mobile radio communication unit to convert a voice signal into an electrical signal. This microphone is encompassed by a holder made of a rubber material, and fitted in a boss formed in the interior of the mobile radio communication unit so that it is stably held in the interior of the unit without being loosened or separated from the unit.

The connection between the microphone and the printed circuit board is achieved using wires involving a welding task.

However, this connection made using wires requires a considerable working time and exhibits a considerably degraded workability.

In order to connect the microphone to the printed circuit board using wires, it is necessary to use a separate process for fixing those wires in accordance with a welding method. However, there is a considerable difficulty in conducting the wire welding process because the microphone has a miniature size so that it is of a built-in type. Furthermore, a considerable time is required to conduct the wire welding process. In addition, the wire welding process may interfere with peripheral components.

Where an external impact is applied to the mobile radio communication unit, the welded portions of the wires connecting the microphone to the printed circuit board may be damaged, so that those wires may be disconnected at the damaged portions. In this case, the degraded welded portions should be connected again. However, this process involves a considerable difficulty. Generally, where a re-welding process is conducted for a welded area, it is difficult to expect a sufficient bonding effect.

Furthermore, there is a limitation in reducing the total thickness of a housing included in the mobile radio communication unit due to the thickness of the holder used to connect the microphone to the printed circuit board. For this reason, there are problems in conventional cases in that it is impossible to achieve miniature and lightness.

### SUMMARY OF THE INVENTION

Therefore, an object of the invention is to solve the above mentioned problems and to provide a connection method for a microphone mounted in a mobile radio communication unit and a connection structure thereof, in which the connection of the microphone to a printed circuit board is made using circular conductive contacts formed at a holder made of a rubber material to protect the microphone, thereby being capable of conveniently achieving the connection between the microphone and the printed circuit board without using wires involving a welding process, as in conventional cases, while reducing the assembling time of the product, achieving an improvement in workability, and preventing an interference with peripheral components and a degradation in the connection resulting in a degradation in the reliability of the product.

Another object of the invention is to provide a connection structure for a microphone mounted in a mobile radio communication unit, in which the connection of the microphone to a printed circuit board is made using a connector coated with a conductive adhesive (or a non-conductive adhesive) at both surfaces thereof, and a movement preventing rim is protruded from the periphery of the microphone at the upper end of the microphone, thereby being capable of conveniently achieving the connection between the microphone and the printed circuit board in accordance with the use of the adhesive eliminating the use of a holder and without using wires involving a welding process, as in conventional cases, while reducing the assembling time of the product, achieving an improvement in workability, minimizing an increase in thickness resulting from the connection between the microphone and the printed circuit board to achieve a miniature and lightness of the housing of the mobile radio communication unit, and preventing an interference with peripheral components and a degradation in the connection resulting in a degradation in the reliability of the product.

In accordance with one aspect, the present invention provides a connection method for a microphone mounted in a mobile radio communication unit, comprising the steps of: fitting the microphone having contacts in a holder defined with a contact region having contacts and a non-contact region at an upper wall thereof; bring the contacts of the microphone into contact with respective inner surfaces of the contacts in the holder; fitting the holder carrying the microphone in a boss formed at an inner surface of a front case included in the mobile radio communication unit; laying a printed circuit board having contacts on the holder fitted in the boss, and then coupling a rear case of the mobile radio communication unit to the front case; and bring the contacts of the printed circuit board into contact with respective outer surfaces of the contacts of the holder in accordance with a pressure generated when the rear case is coupled to the front case, thereby completing an electrical connection of the microphone to the printed circuit board.

In accordance with another aspect, the present invention provides in a mobile radio communication unit including a front case having a boss at an inner surface thereof, a rear case, a printed circuit board, and a microphone mounted in the boss and adapted to convert a voice signal into an electrical signal, a connection structure for electrically connecting the microphone to the printed circuit board, the connection structure comprising: a first conductive region provided at one surface of the printed circuit board and formed with a first contact having a circular ring shape and a second contact centrally arranged inside the first contact; a second conductive region provided at one surface of the microphone and formed with a third contact having a circular ring shape and a fourth contact centrally arranged inside the third contact; a cylindrical holder made of a rubber material and fitted around the microphone, the holder being fitted in the boss and having a circular opening for allowing a voice from a user to enter the microphone fitted in the holder; a third conductive region provided at an upper wall of the holder and formed with a fifth contact having a circular ring shape and a sixth contact centrally arranged inside the fifth contact, the fifth and sixth contacts extending throughout the thickness of the upper wall while being flush with inner and outer surfaces of the upper wall to serve as a connector for electrically connecting the microphone to the printed circuit board; and an annular cushion rim provided at a peripheral edge of the upper wall outside the fifth contact, the annular cushion rim serving to provide a buffering effect when the holder comes into contact with the rear case under pressure, while serving to guide contacting operations respectively conducted between the first and second contacts and the fifth and sixth contacts.

In accordance with another aspect, the present invention provides in a mobile radio communication unit including a front case having a boss at an inner surface thereof, a rear case, a printed circuit board, and a microphone mounted in the boss and adapted to convert a voice signal into an electrical signal, a connection structure for electrically connecting the microphone to the printed circuit board, the connection structure comprising: a first conductive region provided at one surface of the printed circuit board and formed with a first contact having a circular ring shape and a second contact centrally arranged inside the first contact; a second conductive region provided at one surface of the microphone and formed with a third contact having a circular ring shape and a fourth contact centrally arranged inside the third contact; a rubber ring fitted in the boss at an upper end of the boss, the rubber ring serving to prevent the microphone, fitted in the boss, from being separated from the boss; a disk-shaped connector interposed between the printed circuit board and the microphone, the connector having a fifth contact and a sixth contact extending throughout the thickness of the connector to connect the contacts of the microphone to the contacts of the printed circuit board, thereby electrically connecting the microphone to the printed circuit board; a conductive adhesive coated over each surface of the connector and adapted to firmly keep the electrical connection made between the printed circuit board and the microphone by the connector; and a movement preventing rim provided at a periphery of the microphone at an upper end of the microphone and adapted to prevent the connector from moving in a state in which it is seated on the microphone.

### BRIEF DESCRIPTION OF THE DRAWINGS

The above objects, and other features and advantages of the present invention will become more apparent after a reading of the following detailed description when taken in conjunction with the drawings, in which:

FIG. 1 is an exploded perspective view illustrating a microphone connection structure of a mobile radio communication unit according to a first embodiment of the present invention;

FIG. 2 is a plan view illustrating the structure of a holder according to the first embodiment of the present invention;

FIG. 3 is a cross-sectional view taken along the line A-A′ of FIG. 2;

FIG. 4 is a plan view of a microphone according to the first embodiment of the present invention;

FIG. 5 is an assembled sectional view illustrating the connected state of the microphone to a printed circuit board obtained by the holder in accordance with the first embodiment of the present invention;

FIG. 6 is a flow chart illustrating a connection method using the above mentioned connection structure in accordance with the first embodiment of the present invention;

FIG. 7 is a sectional view illustrating a holder structure according to a second embodiment of the present invention;

FIG. 8 is a plan view illustrating a holder structure according to a third embodiment of the present invention;

FIG. 9 is a cross-sectional view taken along the line B-B′ of FIG. 8;

FIG. 10 is an exploded perspective view illustrating a microphone connection structure applied to a mobile radio communication unit in accordance with the fourth embodiment of the present invention;

FIG. 11 is a plan view illustrating the structure of a connector coated, at each surface thereof, with a conductive adhesive having conductive characteristics in accordance with the fourth embodiment of the present invention;

FIG. 12 is a sectional view illustrating the connector according to the fourth embodiment of the present invention;

FIG. 13 is a perspective view illustrating the structure of a microphone according to the fourth embodiment of the present invention;

FIG. 14 is a plan view illustrating the microphone structure according to the fourth embodiment of the present invention;

FIG. 15 is an assembled sectional view illustrating the condition in which the microphone is connected to a printed circuit board via connector in a mobile radio communication unit in accordance with the fourth embodiment of the present invention; and

FIG. 16 is a sectional view illustrating the structure of a connector coated, at each surface thereof, with a non-conductive adhesive having non-conductive characteristics in accordance with the fifth embodiment of the present invention.

### DESCRIPTION OF THE PREFERRED EMBODIMENTS

Now, the present invention will be described in conjunction with a preferred embodiments illustrated in the annexed drawings.

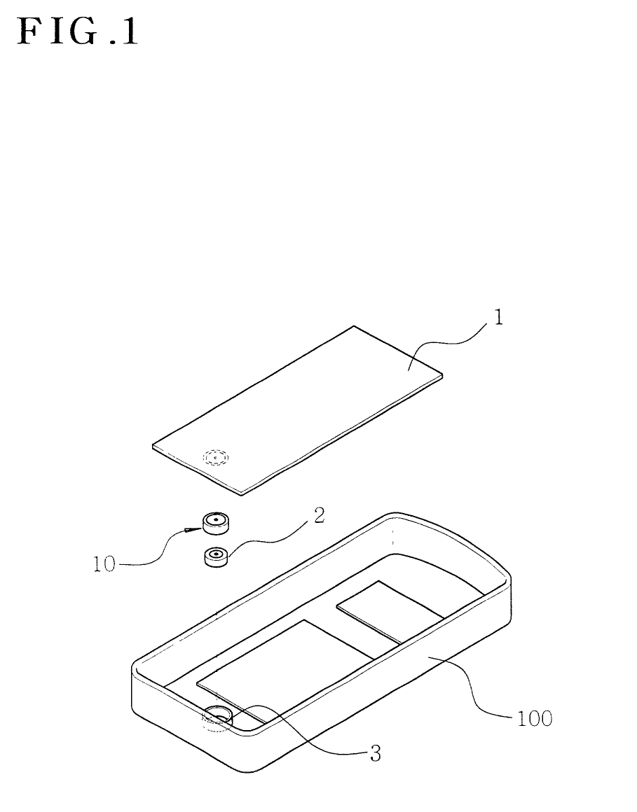

FIG. 1 is an exploded perspective view illustrating a microphone connection structure of a mobile radio communication unit according to a first embodiment of the present invention.

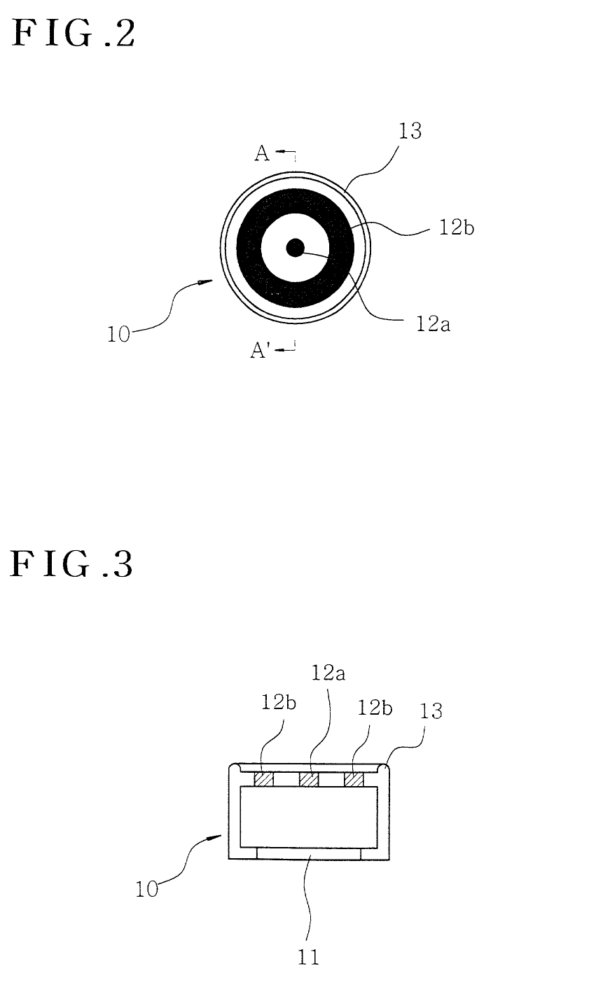

FIG. 2 is a plan view illustrating the structure of a holder according to the first embodiment of the present invention.

FIG. 3 is a cross-sectional view taken along the line A-A′ of FIG. 2.

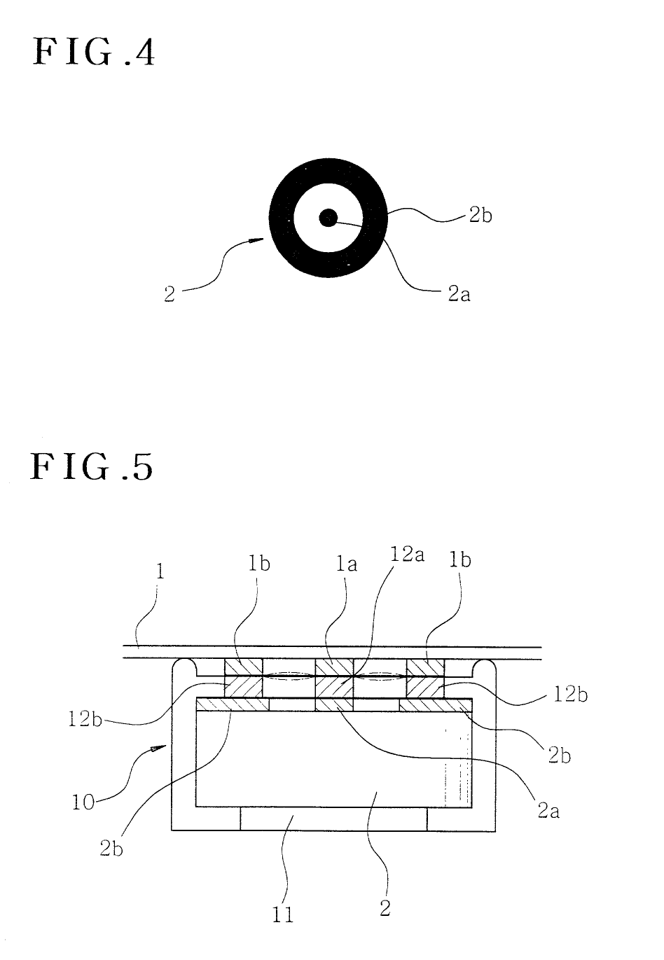

FIG. 4 is a bottom view of a microphone according to the first embodiment of the present invention. FIG. 5 is an assembled sectional view illustrating the connected state of the microphone to a printed circuit board obtained by the holder.

Referring to FIGS. 1 to 5, a mobile radio communication unit is illustrated which includes a printed circuit board 1, and a microphone 2 mounted in a boss 3. The microphone 2 is electrically connected to the printed circuit board 1 so that it converts a voice signal into an electrical signal.

The printed circuit board 1 is provided at one surface thereof with a conductive region where a first contact 1a having a circular ring shape and a second contact 1b centrally arranged inside the first contact 1a are formed.

In similar, the microphone 2 is provided at one surface thereof with a conductive region where a third contact 2a having a circular ring shape and a fourth contact 2b centrally arranged inside the third contact 2a are formed.

A cylindrical holder 10 made of a rubber material is fitted around the microphone 2. In this state, the microphone 2 is fitted in the boss 3 formed at the inner surface of a front case included in the mobile radio communication unit. Thus, the microphone 2 is firmly mounted in the boss 3.

The holder 10 is provided at a lower wall thereof with a circular opening 11 for allowing a voice from the user to enter the microphone 2 fitted in the holder 10.

The holder 10 is also provided at an upper wall thereof with a conductive region where a fifth contact 12a having a circular ring shape and a sixth contact 12b centrally arranged inside the fifth contact 12a are formed, so as to function as a connector for electrically connecting the microphone 2 to the printed circuit board 1. The fifth and sixth contacts 12a and 12b extend throughout the thickness of the upper wall while being flush with inner and outer surfaces of the upper wall.

An annular cushion rim 13 is provided at the peripheral edge of the upper wall of the holder 10 outside the fifth contact 12a. The annular cushion rim 13 serves to provide a buffering effect when the holder 10 comes into contact with a rear case (not shown), while serving to guide contacting operations conducted between the first and second contacts 1a and 1b and the fifth and sixth contacts 12a and 12b.

In the holder 10, the non-conductive portion of the upper wall is made of a hard material whereas the conductive portions of the upper wall corresponding to the fifth and sixth contacts 12a and 12b are made of a soft material. Accordingly, when contacting is made between the first and second contacts 1a and 1b and the third and fourth contacts 2a and 2b, respectively, the fifth and sixth contacts 12a and 12b are compressed between the first and second contacts 1a and 1b and the third and fourth contacts 2a and 2b, respectively. Thus, the connection between the printed circuit board 1 and the microphone 2 is more firmly and easily achieved.

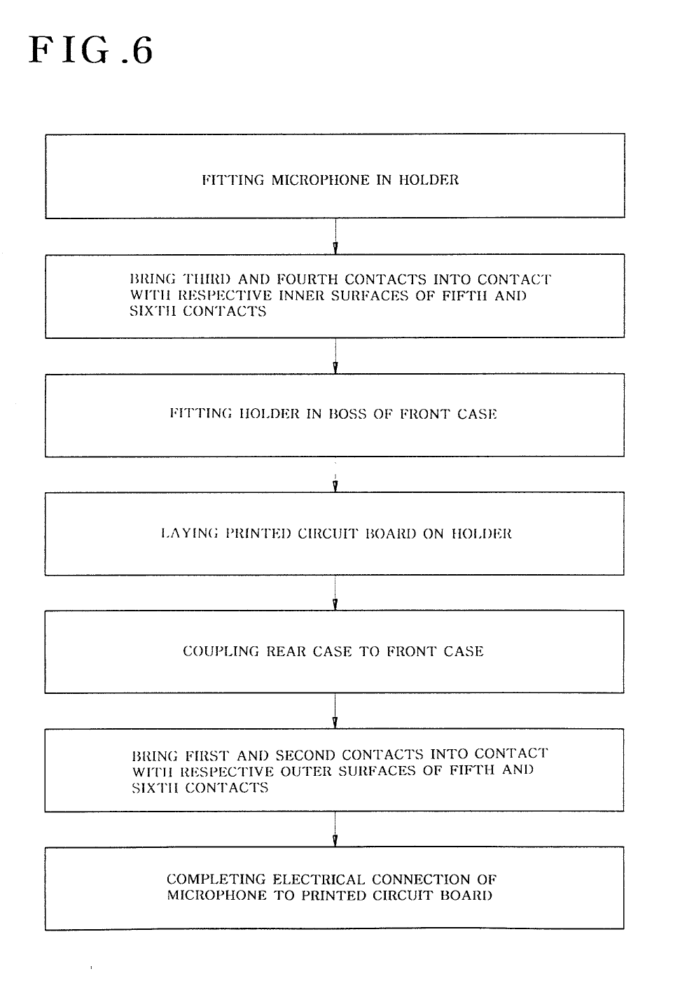

FIG. 6 is a flow chart illustrating a connection method using the above mentioned connection structure in accordance with the present invention.

As shown in FIG. 6, this connection method involves the steps of:

fitting the microphone 2 having the third and fourth contacts 2a and 2b in the holder 10 defined with the contact region having the fifth and sixth contacts 12a and 12b and the non-contact region at the upper wall thereof;

bring the third and fourth contacts 2a and 2b into contact with respective inner surfaces of the fifth and sixth contacts 12a and 12b in the holder 10;

fitting the holder 10 carrying the microphone 2 in the boss 3 formed at the inner surface of the front case 100 included in the mobile radio communication unit;

laying the printed circuit board 1 on the holder 10 fitted in the boss 3, and then coupling the rear case of the mobile radio communication unit to the front case 100; and

bring the first and second contacts 1a and 1b of the printed circuit board 1 into contact with respective outer surfaces of the fifth and sixth contacts 12a and 12b in the holder 10 in accordance with a pressure generated when the rear case is coupled to the front case 100, thereby completing an electrical connection of the microphone 2 to the printed circuit board 1.

Now, this connection method will be described in detail, in conjunction with FIGS. 1 to 6.

First, the printed circuit board 1 is formed at one surface thereof with a conductive region. That is, a first contact 1a having a circular ring shape and a second contact 1b centrally arranged inside the first contact 1a are formed. In similar, the microphone 2 is formed at one surface thereof with a conductive region where a third contact 2a having a circular ring shape and a fourth contact 2b centrally arranged inside the third contact 2a are formed.

Thereafter, the microphone 2 is fitted in the cylindrical holder 10 made of a rubber material. In this state, the holder 10 carrying the microphone 2 is fitted in the boss 3 formed at the inner surface of the front case 100 included in the mobile radio communication unit. Thus, the microphone 2 is firmly mounted in the boss 3.

The printed circuit board 1 is then laid on the holder 10 fitted in the boss 3. At this time, the cushion rim 13 formed at the peripheral edge of the upper wall of the holder 10 comes into contact with the printed circuit board 1.

Subsequently, the rear case of the mobile radio communication unit is coupled to the front case 100. As the rear case is coupled to the front case 100, it applies a pressure to the holder 10. The cushion rim 13 is compressed by the pressure while performing a buffering function.

As the cushion rim 13 is compressed, the first and second contacts 1a and 1b of the printed circuit board 1 and the third and fourth contacts 2a and 2b of the microphone 2 into contact with respective outer surfaces of the fifth and sixth contacts 12a and 12b in the holder 10. Thus, a desired electrical contact state is obtained.

Since the non-conductive portion of the upper wall of the holder 10 is made of a hard material whereas the fifth and sixth contacts 12a and 12b of that upper wall is made of a soft material, the first and second contacts 1a and 1b of the printed circuit board 1 and the third and fourth contacts 2a and 2b of the microphone 2 into contact with respective outer surfaces of the fifth and sixth contacts 12a and 12b in The holder 10 while compressing the fifth and sixth contacts 12a and 12b by a certain pressure. As a result, the printed circuit board 1 and microphone 2 can be electrically connected to each other.

Since the holder 10 is provided at the lower wall thereof with the circular opening 11, the voice from the user can enter the microphone 2 fitted in the holder 10 via the opening 11.

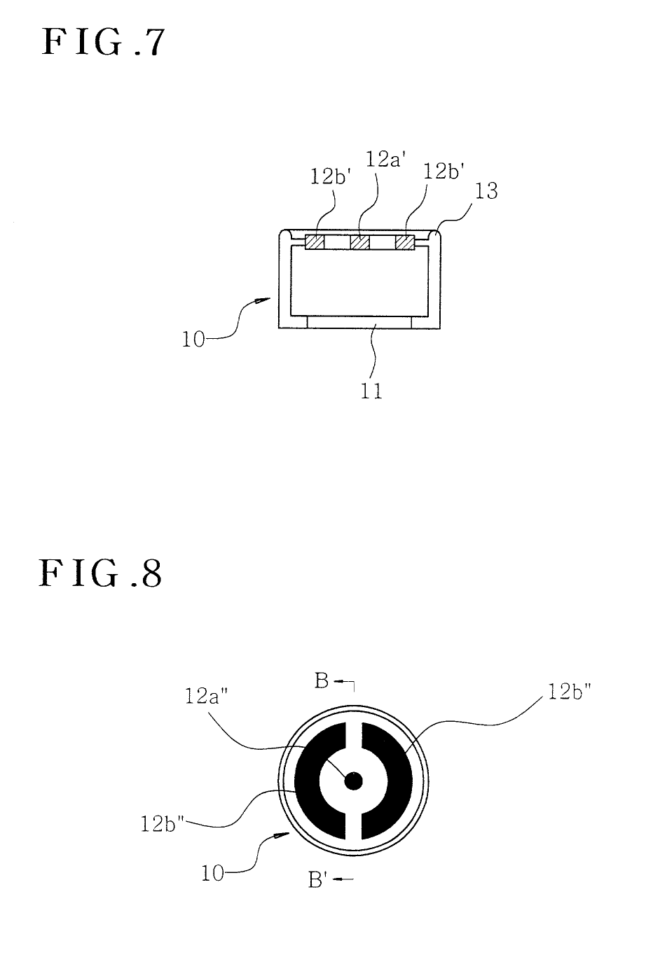

FIG. 7 is a sectional view illustrating a holder structure according to a second embodiment of the present invention.

As shown in FIG. 7, the holder 10 has fifth and sixth contacts 12a′ and 12b′ formed at the upper wall thereof in such a fashion that they are axially protruded from the upper wall to form steps on the inner and outer surfaces of the upper wall.

In accordance with this structure in which the fifth and sixth contacts 12a′ and 12b′ are axially protruded from the upper wall of the holder 10 to form steps on the inner and outer surfaces of the upper wall, it is possible to more easily achieve a desired electrical connection between the printed circuit board 1 and the microphone 2, as compared to the above mentioned first embodiment.

In this embodiment, elements respectively corresponding to those of the first embodiment are denoted by the same reference numerals.

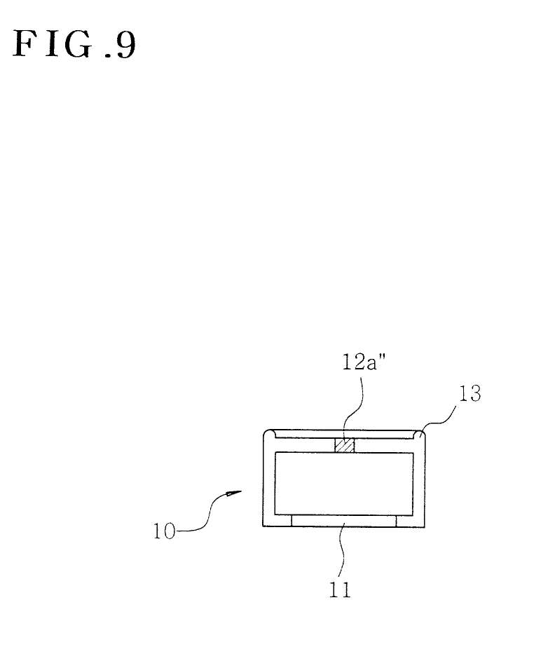

Meanwhile, FIGS. 8 and 9 illustrate a third embodiment of the present invention. FIG. 8 is a plan view illustrating a holder structure whereas FIG. 9 is a cross-sectional view taken along the line B-B′ of FIG. 8.

In accordance with this embodiment, the holder 10 is provided at the upper wall thereof with two fifth contacts 12a″ having a semicircular ring shape while facing each other, and with a sixth contact 12b″ centrally arranged inside the fifth contact 12a″. This structure is adapted to prevent noise from being generated when the printed circuit board 1 and microphone 2 are electrically connected. Although two fifth contacts 12a″ having a semicircular ring shape are formed in accordance with this embodiment, a plurality of contacts having an arc shape may be formed as fifth contacts.

In this embodiment, elements respectively corresponding to those of the first embodiment are denoted by the same reference numerals.

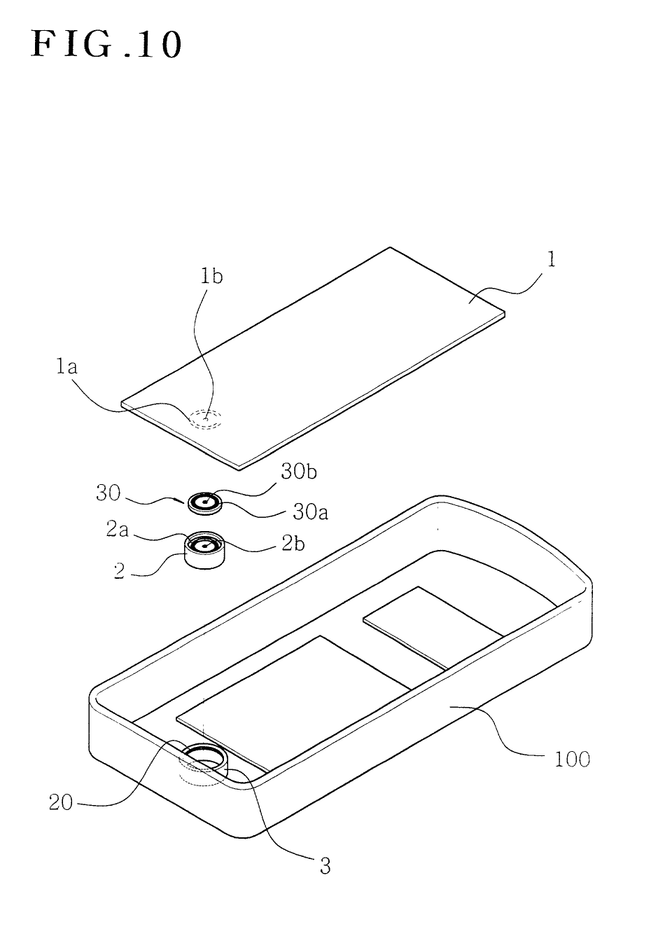

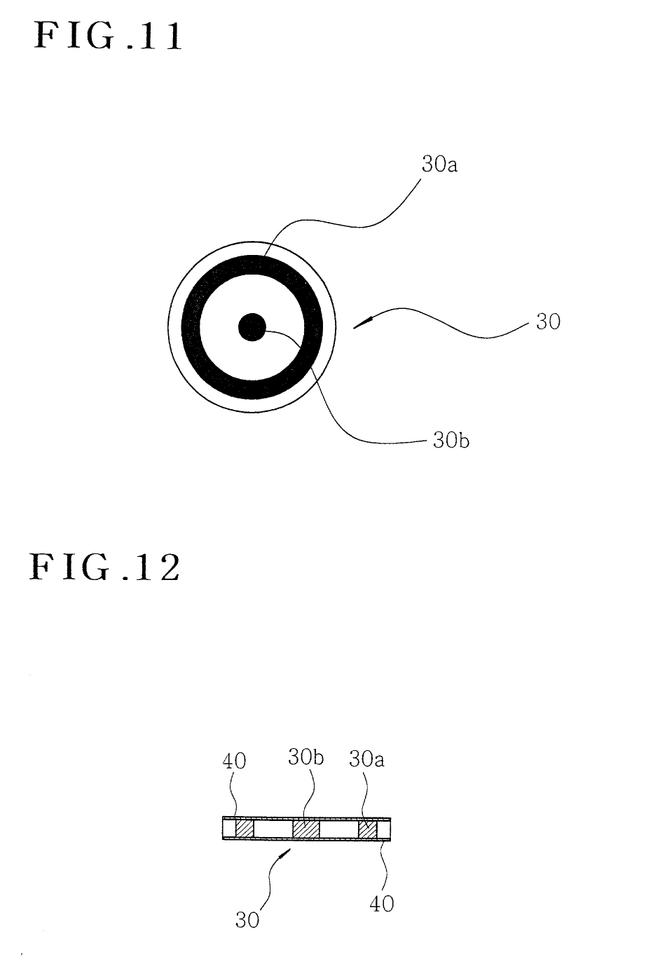

FIGS. 10 to 15 illustrate a fourth embodiment of the present invention. FIG. 10 is an exploded perspective view illustrating a microphone connection structure applied to a mobile radio communication unit in accordance with the fourth embodiment of the present invention. FIG. 11 is a plan view illustrating the structure of a connector coated, at its surface, with a conductive adhesive having conductive characteristics in accordance with the fourth embodiment of the present invention.

FIG. 12 is a sectional view illustrating the connector according to the fourth embodiment of the present invention.

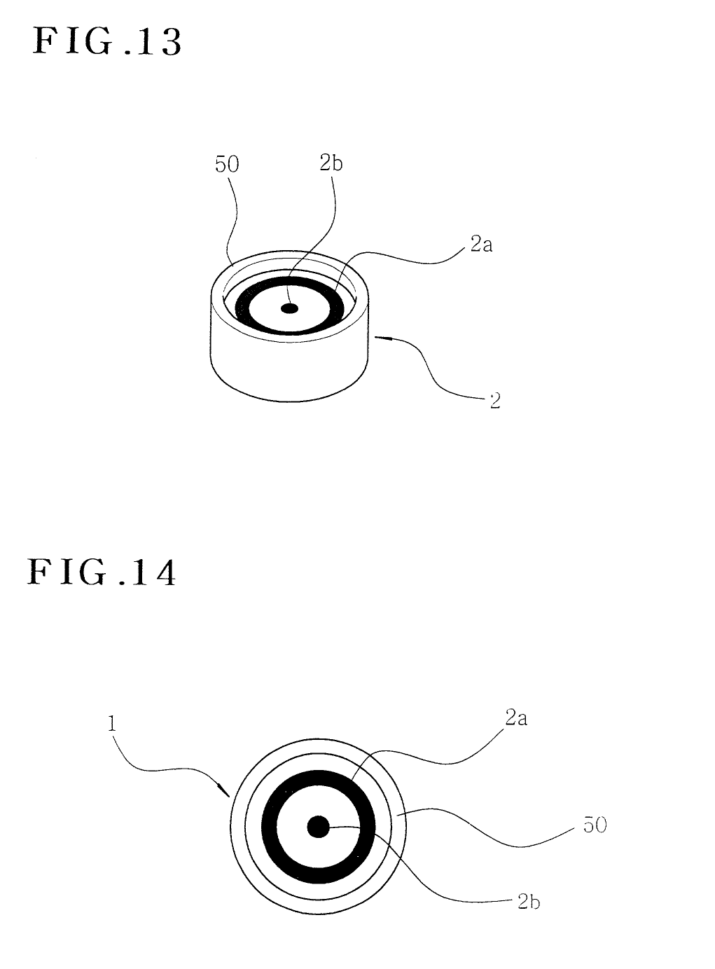

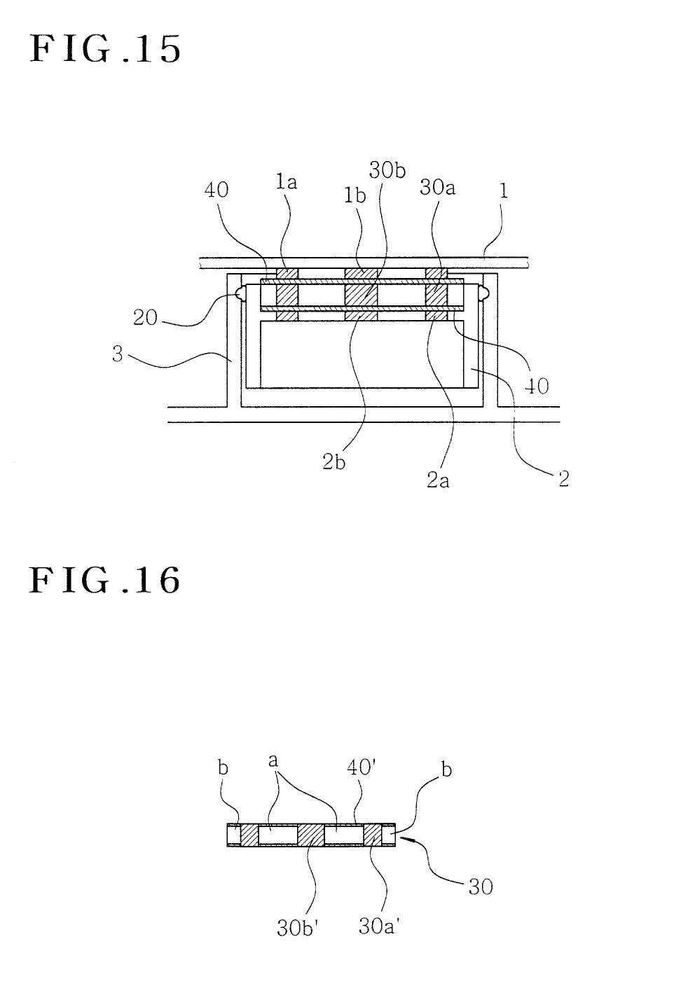

FIG. 13 is a perspective view illustrating the structure of a microphone according to the fourth embodiment of the present invention. FIG. 14 is a plan view illustrating the microphone structure according to the fourth embodiment of the present invention. FIG. 15 is an assembled sectional view illustrating the condition in which the microphone is connected to a printed circuit board via connector in a mobile radio communication unit in accordance with the fourth embodiment of the present invention.

Referring to FIGS. 10 to 15, a mobile radio communication unit is illustrated which has a configuration similar to that of the first embodiment in that it includes a printed circuit board 1 provided at one surface thereof with a conductive region, where a first contact 1a having a circular ring shape and a second contact 1b centrally arranged inside the first contact 1a are formed, and a microphone 2 provided at one surface thereof with a conductive region, where a third contact 2a having a circular ring shape and a fourth contact 2b centrally arranged inside the third contact 2a are formed, the microphone 2 being electrically connected to the printed circuit board 1 so that it converts a voice signal into an electrical signal, and a boss 3 for mounting the microphone 2 therein.

A rubber ring 20 is fitted in the boss 3 at the upper end of the boss 3. The rubber ring 20 serves to prevent the microphone 2, fitted in the boss 3, from being separated from the boss 3.

A disk-shaped connector 30 is interposed between the printed circuit board 1 and the microphone 2. The connector 30 has a seventh contact 30a and an eighth contact 30b extending throughout the thickness of the connector 30. The seventh and eighth contacts 30a and 30b serve to connect the contacts 2a and 2b of the microphone 2 to the contacts 1a and 1b of the printed circuit board 1, thereby electrically connecting the microphone 2 to the printed circuit board 1.

In order to firmly keep the electrical connection between the printed circuit board 1 and the microphone 2 by the connector 30, a conductive adhesive 40 is coated over both surfaces of the connector 30.

A movement preventing rim 50 is provided at the periphery of the microphone 2 at the upper end of the microphone 2 in order to prevent the connector 30 from moving in a state in which it is seated on the microphone 2.

Now, this configuration according to the fourth embodiment of the present invention will be described in detail, in conjunction with FIGS. 10 to 15.

First, the printed circuit board 1 is formed at one surface thereof with a conductive region. That is, the first contact 1a having a circular ring shape and the second contact 1b centrally arranged inside the first contact 1a are formed. In similar, the microphone 2 is formed at one surface thereof with a conductive region where the third contact 2a having a circular ring shape and the fourth contact 2b centrally arranged inside the third contact 2a are formed.

Also, the movement preventing rim 50 is provided at the periphery of the microphone 2 at the upper end of the microphone 2. The rubber ring 20 is fitted in the boss 3 at the upper end of the boss 3. As mentioned above, the boss 3 is formed at the front case 100 of the mobile radio communication unit. The rubber ring 20 serves to prevent the microphone 2, fitted in the boss 3, from being separated from the boss 3.

The microphone 2 is then fitted in the boss 3 of the front case 100 carrying the rubber ring 10.

Thereafter, the connector 30, which has the seventh and eight contacts 30a and 30b extending throughout the thickness thereof, is seated on the microphone 2. In this state, the eighth contact 30b of the connector 30 comes into contact with the third and fourth contacts 2a and 2b of the microphone 2, so that it is electrically connected with those contacts 2a and 2b.

When the printed circuit board 1 having the first and second contacts 1a and 1b come into tight contact with the upper surface of the connector 30, the seventh contact 30a of the connector 30 is electrically connected with the first and second contacts 1a and 1b.

Since the connector 30 has a disk structure with a very small thickness while being coated with a conductive adhesive 40 at both surfaces thereof, the electrical connection between the printed circuit board 1 and the microphone 2 by he connector 20 can be reliably maintained. Also, the total thickness of the mobile radio communication unit can be reduced.

Although the conductive adhesive 40 is coated over both surfaces of the connector 30 in the illustrated case, it may be coated on the first and second contacts 1a and 1b of the printed circuit board 1 and the third and fourth contacts 2a and 2b of the microphone 2. In this case, of course, the same effect as that of the fourth embodiment is obtained.

Meanwhile, FIG. 16 illustrates a fifth embodiment of the present invention. As shown in FIG. 16, the connector 30 is provided with a ninth contact 30a′ corresponding to the seventh contact 30a of the fourth embodiment and a tenth contact 30b′ corresponding to the eighth contact 30b of the fourth embodiment. The ninth and tenth contacts 30a′ and 30b′ are slightly protruded from associated surfaces of the connector 30. A non-conductive adhesive 40′ is coated on non-contact regions a and b where the ninth and tenth contacts 30a′ and 30b′ are not formed.

When the ninth and tenth contacts 30a′ and 30b′ of the connector 30 come into contact with the first and second contacts 1a and 1b of the printed circuit board 1, the non-conductive adhesive 40′ coated only on the non-contact regions a and b of the connector 30 serves to allow the connector 30 to come into tight contact with the printed circuit board 1 and microphone 2 at its upper and lower surfaces, respectively, thereby maintaining the connection state made between the printed circuit board 1 and the microphone 2 by the connector 30.

In this embodiment, elements respectively corresponding to those of the first through fourth embodiments are denoted by the same reference numerals. No description will be made for those elements.

As apparent from the above description, the present invention provides a connection method for a microphone mounted in a mobile radio communication unit and a connection structure thereof, which are capable of conveniently achieving the connection of the microphone to the printed circuit board without using wires involving a welding process while reducing the assembling time of the product, achieving an improvement in workability, preventing an interference with peripheral components and a degradation in the connection resulting in a degradation in the reliability of the product, and minimizing an increase in thickness resulting from the connection between the microphone and the printed circuit board to achieve a miniature and lightness of the housing of the mobile radio communication unit.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A connection method for a microphone mounted in a mobile radio communication unit, comprising the steps of:
fitting the microphone having contacts in a holder defined with a contact region having contacts and a non-contact region at an upper wall thereof;
bring the contacts of the microphone into contact with respective inner surfaces of the contacts in the holder;
fitting the holder carrying the microphone in a boss formed at an inner surface of a front case included in the mobile radio communication unit;
laying a printed circuit board having contacts on the holder fitted in the boss, and then coupling a rear case of the mobile radio communication unit to the front case; and
bring the contacts of the printed circuit board into contact with respective outer surfaces of the contacts of the holder in accordance with a pressure generated when the rear case is coupled to the front case, thereby completing an electrical connection of the microphone to the printed circuit board.

2. In a mobile radio communication unit including a front case having a boss at an inner surface thereof, a rear case, a printed circuit board, and a microphone mounted in the boss and adapted to convert a voice signal into an electrical signal, a connection structure for electrically connecting the microphone to the printed circuit board, the connection structure comprising:
a first conductive region provided at one surface of the printed circuit board and formed with a first contact having a circular ring shape and a second contact centrally arranged inside the first contact;
a second conductive region provided at one surface of the microphone and formed with a third contact having a circular ring shape and a fourth contact centrally arranged inside the third contact;
a cylindrical holder made of a rubber material and fitted around the microphone, the holder being fitted in the boss and having a circular opening for allowing a voice from a user to enter the microphone fitted in the holder;
a third conductive region provided at an upper wall of the holder and formed with a fifth contact having a circular ring shape and a sixth contact centrally arranged inside the fifth contact, the fifth and sixth contacts extending throughout the thickness of the upper wall while being flush with inner and outer surfaces of the upper wall to serve as a connector for electrically connecting the microphone to the printed circuit board; and
an annular cushion rim provided at a peripheral edge of the upper wall outside the fifth contact, the annular cushion rim serving to provide a buffering effect when the holder comes into contact with the rear case under pressure, while serving to guide contacting operations respectively conducted between the first and second contacts and the fifth and sixth contacts.

3. The connection structure according to claim 2, wherein the fifth and sixth contacts are protruded from the inner and outer surfaces of the upper wall so that steps are formed between the fifth and sixth contacts and the upper wall at the inner and outer surfaces of the upper wall, respectively.

4. The connection structure according to claim 2, wherein the fifth contact has a plurality of contact portions each having an arc shape.

5. The connection structure according to any one of claims 2 to 4, wherein the upper wall of the holder is made of a soft material able to be compressed at a portion thereof corresponding to the third conductive region while being made of a hard material at a non-conductive portion thereof other than the third conductive region.

6. In a mobile radio communication unit including a front case having a boss at an inner surface thereof, a rear case, a printed circuit board, and a microphone mounted in the boss and adapted to convert a voice signal into an electrical signal, a connection structure for electrically connecting the microphone to the printed circuit board, the connection structure comprising:
a first conductive region provided at one surface of the printed circuit board and formed with a first contact having a circular ring shape and a second contact centrally arranged inside the first contact;
a second conductive region provided at one surface of the microphone and formed with a third contact having a circular ring shape and a fourth contact centrally arranged inside the third contact;
a rubber ring fitted in the boss at an upper end of the boss, the rubber ring serving to prevent the microphone, fitted in the boss, from being separated from the boss;
a disk-shaped connector interposed between the printed circuit board and the microphone, the connector having a fifth contact and a sixth contact extending throughout the thickness of the connector to connect the contacts of the microphone to the contacts of the printed circuit board, thereby electrically connecting the microphone to the printed circuit board;
a conductive adhesive coated over each surface of the connector and adapted to firmly keep the electrical connection made between the printed circuit board and the microphone by the connector; and
a movement preventing rim provided at a periphery of the microphone at an upper end of the microphone and adapted to prevent the connector from moving in a state in which it is seated on the microphone.

7. The connection structure according to claim 6, wherein:
the fifth and sixth contacts of the connector are slightly protruded from associated surfaces of the connector, respectively; and
a non-conductive adhesive is coated on non-contact regions arranged around the sixth and seventh contacts, the non-conductive adhesive having non-conductive characteristics and serving to allow the connector to come into tight contact with the printed circuit board and the microphone at upper and lower surfaces thereof, respectively, thereby firmly keeping the connection state made between the printed circuit board and the microphone by the connector.
